(19) United States
(12) Patent Application Publication
(10) Pub. No.: US 2002/0153862 A1
(43) Pub. Date: Oct. 24, 2002

(54) Portable telephone set charging system and charging method

(76) Inventor: Nobuo Kuroki, Tokyo (JP)

Correspondence Address: McGinn & Gibb, PLLC, Suite 200, 8321 Old Courthouse Road, Vienna, VA, 22182-3817, US

(21) Appl. No.: 10/127,545

(22) Filed: Apr. 23, 2002

(30) Foreign Application Priority Data
Apr. 24, 2001 (JP) 126021/2001

(51) Int. Cl. H02J 7/00

(52) U.S. Cl. 320/114

(57) ABSTRACT

A charging system for charging a portable telephone set includes a plurality of charging apparatuses and a charging controller. The charging apparatuses can simultaneously charge a plurality of portable telephone sets. The charging controller causes the charging apparatuses to start charging on the basis of exchange of information with the portable telephone sets via a base station, identifies the portable telephone sets, and bills the usr for the use of the charging apparatuses. A portable telephone set charging method is also disclosed.

### BACKGROUND OF THE INVENTION

1. Field of the Invention

The present invention relates to a portable telephone set and, more particularly, to a portable telephone set charging system and charging method which can easily charge a portable telephone set when a person stays out.

2. Description of the Prior Art

Conventionally, a portable telephone set whose battery capacity runs short must be brought back to the user's house or the like where a charging apparatus is left, and must be charged. During that charging period, the portable telephone set cannot be used.

To solve the above problem, the user may carry a charging apparatus with him/her so as to quickly charge a portable telephone set when its battery capacity runs short, which is cumbersome.

As a measure against the shortage of the battery capacity, Japanese Unexamined Patent Publication No. 2000-101756 discloses a portable telephone set charging system for charging a portable telephone set by inserting coins.

However, this portable telephone set charging system cannot be used by a user who does not have any coins on him or her.

### SUMMARY OF THE INVENTION

The present invention has been made to eliminate the conventional drawbacks, and has as its object to provide a portable telephone set charging system and charging method capable of easily charging a portable telephone set when a person stays out.

In order to achieve the above object, according to the first primary aspect of the present invention, there is provided a portable telephone set charging system comprising a plurality of charging apparatuses which can simultaneously charge a plurality of portable telephone sets, and a charging controller which causes the charging apparatuses to start charging on the basis of exchange of information with the portable telephone sets via a base station, identifies the portable telephone sets, and bills the user for use of the charging apparatuses.

This system allows the user to easily charge the portable telephone set outside his or her home even if he/she does not have any cash such as coins on him or her.

The portable telephone set charging system according to the first primary aspect has the following secondary aspects.

More specifically, the charging controller comprises a message transmission/reception unit which exchanges information with the portable telephone sets via the base station, and the message transmission/reception unit can receive charging start request information from each of the portable telephone sets, transmit charging start confirmation information as a response to the charging start request information to the portable telephone set, and receive transmission start OK information as a response to the charging start confirmation information from the portable telephone set.

The portable telephone set charging system exchanges information with the portable telephone set, and authenticates the portable telephone set in order to bill the user the use fee at the same time as charging control of the charging apparatus.

When each of the portable telephone sets is mounted on each of the charging apparatuses and the charging apparatus receives charging start request information from the portable telephone set via the charging controller, the charging controller transmits charging start confirmation information to the portable telephone set.

If no portable telephone set is mounted or no charging start request information is received, charging preparations are determined not to have been completed, and charging is suspended without transmitting any charging start confirmation information.

Each of the charging apparatuses is provided with a private information input unit, and when private information is received by the private information input unit of each of the portable telephone sets, the message transmission/reception unit can transmit charging start request information to the portable telephone set on the basis of the private information, and receive charging start information as a response to the charging start request information from the portable telephone set.

With this means, the portable telephone set charging system exchanges information with the portable telephone set on the basis of private information inputted, and authenticates the portable telephone set in order to bill the user a used fee of the charging apparatus at the same time as charging control of the charging apparatus.

The charging controller can provide used fee information to each of the portable telephone sets.

The portable telephone set can confirm the used fee of charging by information transmitted and provided from the charging controller.

The plurality of charging apparatuses and the charging controller are connected by wire or wirelessly. The plurality of charging apparatuses and the charging controller are integrated.

This can make the portable telephone set charging system compact.

When each of the portable telephone sets is empty of battery capacity, the portable telephone set can be charged for a predetermined time until start of actual charging without exchanging information between the portable telephone set and the charging controller.

Accordingly, exchange of information can be ensured between the portable telephone set which is empty of battery capacity and the portable telephone set charging system.

A dealer different from a dealer for the portable telephone set charging system can provide charging of the charging apparatuses.

This facilitates ensuring the installation location of the charging apparatus. This is because a dealer who provides a location where the charging apparatus is installed, and a dealer who provides the portable telephone set charging system need not be the same.

The user can be billed a used fee for use of the charging apparatuses together with a telephone rate.

This means enables easy collection of the used fee.

In order to achieve the above object, according to the second primary aspect of the present invention, there is provided a portable telephone set charging method comprising the step of simultaneously charging a plurality of portable telephone sets, and the step of starting charging on the basis of exchange of information with the portable telephone sets, identifying the portable telephone sets, and billing the user for charging of the portable telephone sets.

Further, in order to achieve the above object, according to the third primary aspect of the present invention, there is provided a portable telephone set charging method comprising the step of simultaneously charging a plurality of portable telephone sets, and the step of starting charging on the basis of exchange of information with the portable telephone sets via a base station, identifying the portable telephone sets, and billing the user for charging of the portable telephone sets.

By these method aspects, similar to the first primary aspect, the user can easily charge the portable telephone set outside his or her home even if he/she does not have any cash such as coins on him or her.

As is apparent from the above aspects, according to the present invention, a plurality of portable telephone sets are simultaneously charged. This charging starts on the basis of exchange of information with the portable telephone sets. At the same time, the portable telephone sets are identified and the user is billed for the charging. Even if the user does not have any cash such as coins on him or her, he/she can easily charge the portable telephone set.

The message transmission/reception unit receives charging start request information from the portable telephone set, transmits charging start confirmation information as a response to the charging start request information to the portable telephone set, and receives transmission start OK information as a response to the charging start confirmation information from the portable telephone set. The portable telephone set charging system can exchange information with the portable telephone set, and can identify the portable telephone set in order to bill the user the used fee of the charging apparatus at the same time as charging control thereof.

The above and many other objects, features and advantages of the present invention will become manifest to those skilled in the art upon making reference to the following detailed description and accompanying drawings in which preferred embodiments incorporating the principle of the present invention are shown by way of illustrative examples.

### BRIEF DESCRIPTION OF THE DRAWINGS

FIG. 1 is a block diagram showing the schematic arrangement of a portable telephone set charging system according to the present invention;

FIGS. 2A and 2B are flow charts for explaining the overall operation of the portable telephone set charging system shown in FIG. 1;

FIG. 3 is a block diagram showing the schematic arrangement of a modification of the portable telephone set charging system according to the present invention; and

FIGS. 4A and 4B are flow charts for explaining the overall operation of the portable telephone set charging system shown in FIG. 3.

### DETAILED DESCRIPTION OF THE PREFERRED EMBODIMENTS

Preferred embodiments of the present invention will be described below with reference to the accompanying drawings.

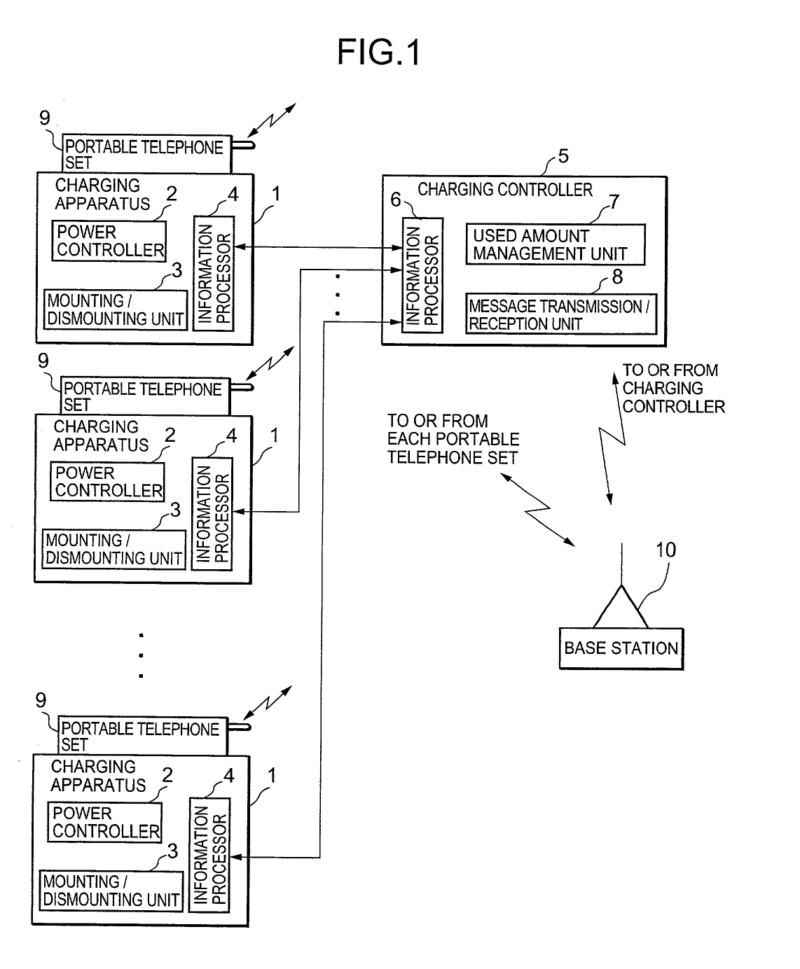

FIG. 1 is a block diagram showing the schematic arrangement of a portable telephone set charging system according to the embodiment of the present invention.

As shown in FIG. 1, the portable telephone set charging system comprises a plurality of charging apparatuses 1, which simultaneously charge corresponding portable telephone sets 9. Each portable telephone set 9 is running short in battery capacity and needs to be charged.

The charging apparatuses 1 are connected to a charging controller 5, which exchanges information with the portable telephone sets 9 via a base station 10. At the same time as charging control of the charging apparatuses 1, the charging controller 5 identifies the portable telephone sets 9 in order to bill the user the used fee of the charging apparatus.

Each charging apparatus 1 has a power controller 2, which supplies power for charging the portable telephone set 9.

The charging apparatus 1 has a mounting/dismounting unit 3, which monitors mounting/dismounting of the portable telephone set 9 to be charged.

Further, the charging apparatus 1 has an information processor 4, which performs information analysis and control of the charging apparatus 1, and transmission/reception with respect to the charging controller 5.

The charging controller 5 has an information processor 6, which performs information analysis and control of the charging controller 5, and transmission/reception with respect to the charging apparatus 1.

The charging controller 5 has a used amount management unit 7, which manages a used amount of the portable telephone set charging system, calculates a used fee thereof, and measures a used time thereof.

The charging controller 5 has a message transmission/reception unit 8, which exchanges information and messages with the portable telephone set 9 and analyzes information and messages.

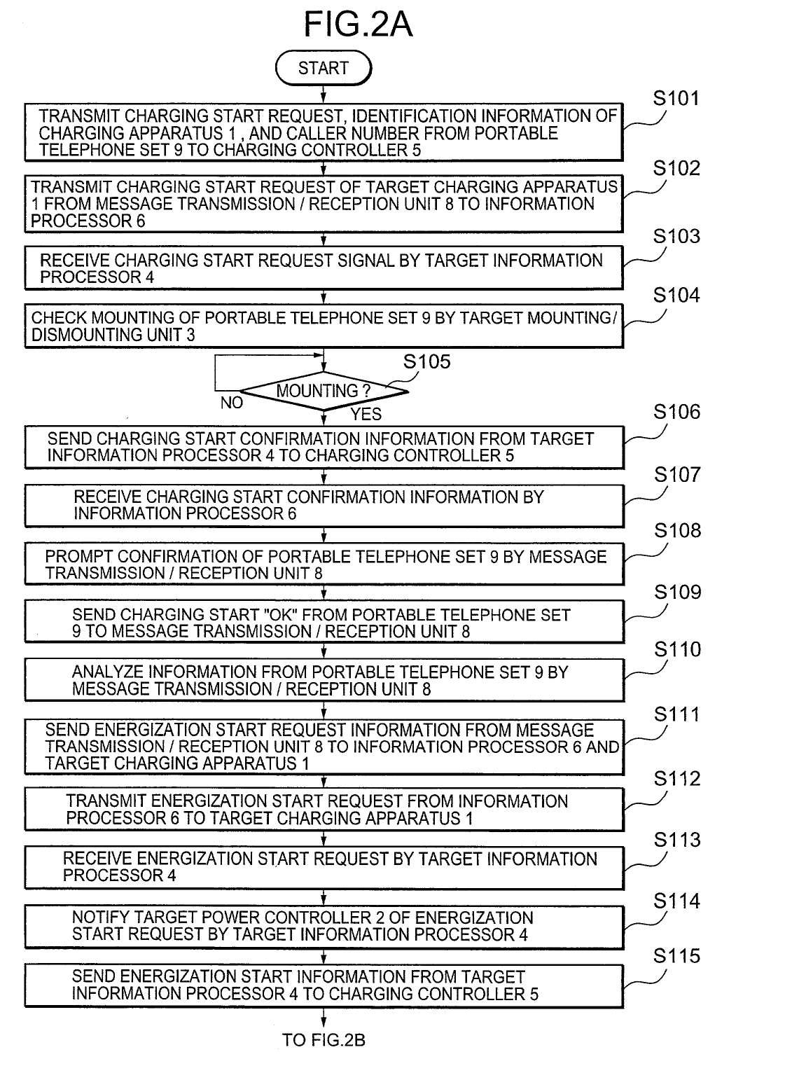

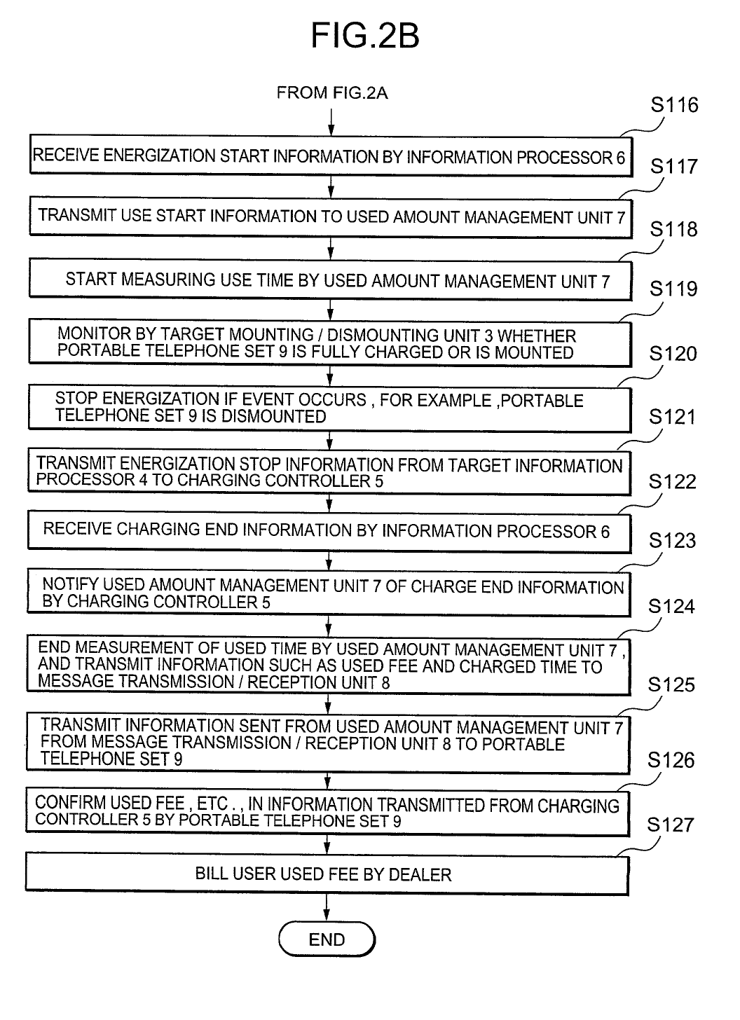

FIGS. 2A and 2B are flow charts for explaining the overall operation of the portable telephone set charging system shown in FIG. 1.

As shown in FIG. 2A, in step S101, the portable telephone set 9 transmits information such as a charging start request of starting charging, identification information of the charging apparatus 1, and a caller number by voice communication to the message transmission/reception unit 8 of the charging controller 5 via the base station 10.

The caller number transmitted from the portable telephone set 9 is used for user authenticate and billing.

Transmission from the portable telephone set 9 to the charging controller 5 is realized by a means such as a telephone, SMS message, or mail.

In step S102, the message transmission/reception unit 8 requests the information processor 6 to transmit charging start request information in order to start charging a target charging apparatus 1 on the basis of the identification information of the charging apparatus 1 sent from the portable telephone set 9.

In step S103, the information processor 4 of the target charging apparatus 1 receives the charging start request information.

In step S104, the mounting/dismounting unit 3 of the target charging apparatus 1 checks mounting of the portable telephone set 9.

If it is determined in step S105 that the portable telephone set 9 is not mounted, charging preparations are determined not to have been completed, and the flow waits until the portable telephone set 9 is mounted.

Even if the portable telephone set 9 is mounted on the mounting/dismounting unit 3, charging preparations are determined not to have been completed, and the flow waits until the information processor 4 of target the charging apparatus 1 receives a charging start request.

If the two conditions are satisfied, the flow advances to step S106.

In step S106, the information processor 4 of the target charging apparatus 1 sends charging start confirmation information to the charging controller 5 in order to notify the latter of the completion of charging preparations.

In step S107, the information processor 6 receives the charging start confirmation request.

In step S108, the message transmission/reception unit 8 sends a charging start confirmation request to the portable telephone set 9 to prompt its confirmation. In this case, the transmitted caller number is used.

If the start of charging is permitted in step S109, a corresponding operation is performed to send transmission start OK information from the portable telephone set 9 to the message transmission/reception unit 8 of the charging controller 5.

In step S110, the message transmission/reception unit 8 analyzes the information sent from the portable telephone set 9. By this analysis, the portable telephone set 9 is identified.

In step S2111, the message transmission/reception unit 8 sends energization start request information to the information processor 6 on the basis of the analysis.

In step S112, the information processor 6 transmits the energization start request information to the target charging apparatus 1.

In step S113, the information processor 4 of the target charging apparatus 1 receives the energization start request.

In step S114, the target charging apparatus 1 notifies the power controller 2 of the energization start request.

In step S115, the information processor 4 of the target charging apparatus 1 sends energization start information to the charging controller 5.

As shown in FIG. 2B, in step S116, the information processor 6 receives the energization start information.

In step S117, use start information is transmitted to the used amount management unit 7.

In step S118, the used amount management unit 7 starts measuring the use time.

In step S119, the mounting/dismounting unit 3 of the target charging apparatus 1 monitors whether the portable telephone set 9 is fully charged or is mounted.

If any event occurs in step S120, e.g., the portable telephone set 9 is dismounted, the power controller 2 of the target charging apparatus 1 stops energization.

In step S121, the information processor 4 of the target charging apparatus 1 transmits energization stop information to the charging controller 5.

In step S122, the information processor 6 receives charging end information.

In step S123, the charging controller 5 notifies the used amount management unit 7 of the charging end information.

In step S124, the used amount management unit 7 ends the measurement of the used time, and transmits information such as the used fee and charged time to the message transmission/reception unit 8.

In step S125, the message transmission/reception unit 8 transmits the information sent from the used amount management unit 7 to the portable telephone set 9.

In step S126, the portable telephone set 9 confirms the used fee contained in the information transmitted from the charging controller 5.

In step S127, as for billing, a dealer who possesses the portable telephone set charging system bills the user the used fee on the basis of the caller number and the used time.

According to the present invention, pieces of information are exchanged between the portable telephone set 9 and the portable telephone set charging system upon reception of a charging start request from the portable telephone set 9. The portable telephone set charging system can identify the user, and can bill the user the use fee. Even if the user does not have any cash on him or her, he/she can charge the portable telephone set 9. The user can easily charge the portable telephone set 9 outside his or her home without adding any new function to it.

For a case wherein the portable telephone set 9 becomes empty of power, the portable telephone set charging system has a mechanism of energizing the portable telephone set 9 for a predetermined time by the power controller 2 until the start of actual charging while the portable telephone set 9 is mounted on the mounting/dismounting unit 3 of the charging apparatus 1. This enables exchanging information between the portable telephone set 9 and the message transmission/reception unit 8.

When the charging apparatus 1 and charging controller 5 are located very close to each other, they need not always be independent of each other and may be integrated. The information processor 4 of the charging apparatus 1 and the information processor 6 of the charging controller 5 can be connected by wire or wirelessly. If the charging apparatus 1 and charging controller 5 are located apart from each other, wireless connection is advantageous for the purpose of a compact arrangement.

As for the used fee, the dealer who manages the portable telephone set charging system made up of the charging apparatus 1 and charging controller 5 directly bills the user, or collects the used fee by using, e.g., a collection agency of collecting the used fee together with a telephone rate by a telephone company. In the latter case, collection of the used fee is easier.

A dealer who provides a location where the charging apparatus 1 is installed, and a dealer who provides the portable telephone set charging system need not be the same. This facilitates ensuring the installation location of the charging apparatus 1.

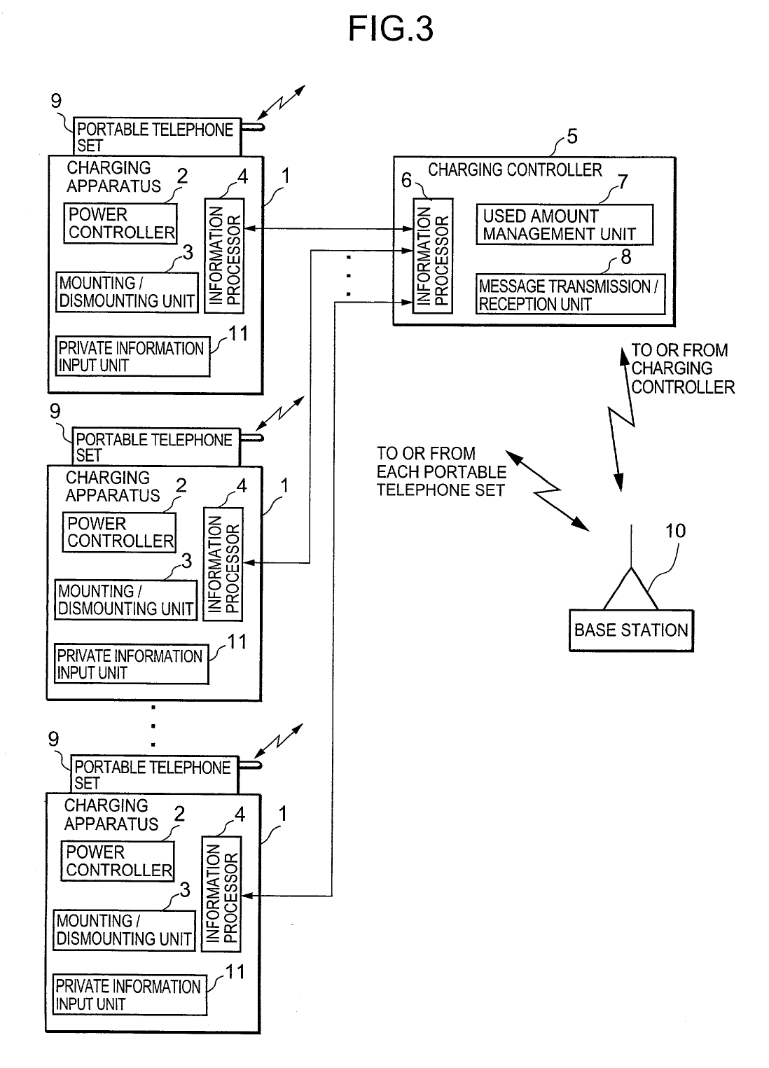

FIG. 3 is a block diagram showing the schematic arrangement of a modification of the portable telephone set charging system shown in FIG. 1.

As shown in FIG. 3, compared to the system of FIG. 1, each charging apparatus 1 is further provided with a private information input unit 11. The private information input unit 11 receives private information for the portable telephone set 9, e.g., such as a telephone number.

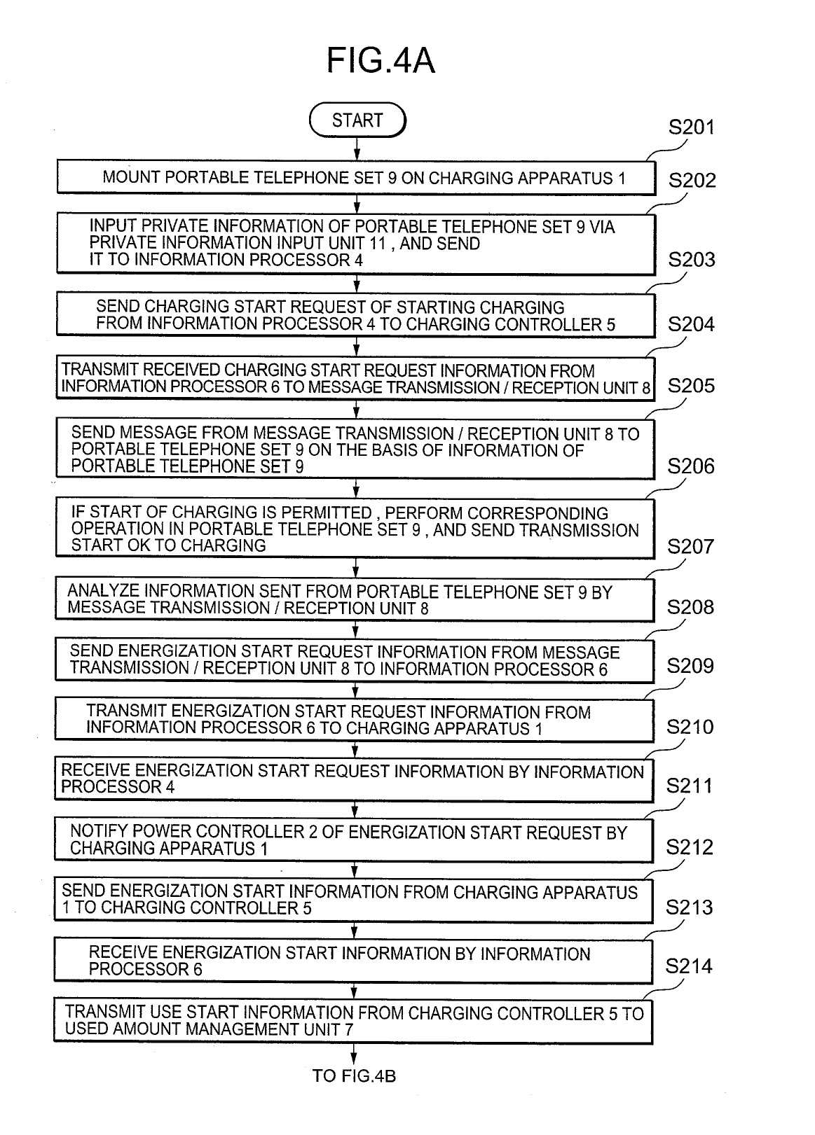

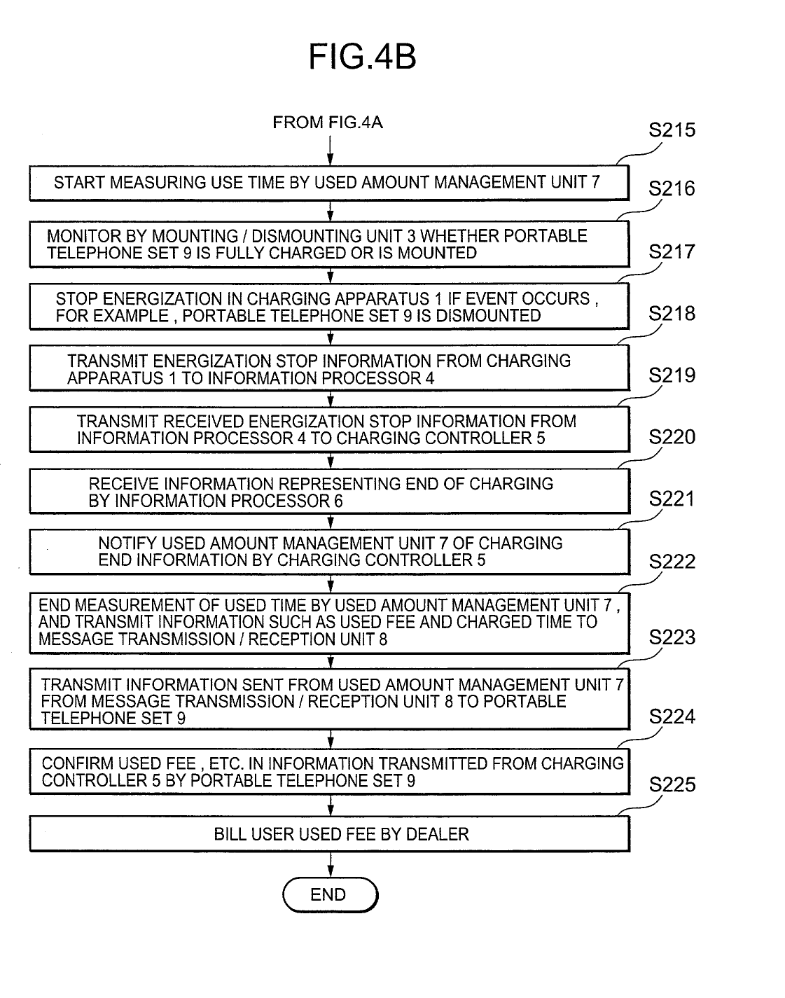

FIGS. 4A and 4B are flow-charts for explaining the overall operation of the portable telephone set charging system shown in FIG. 3.

As shown in FIG. 4A, in step S201, the portable telephone set 9 is mounted on the mounting/dismounting unit 3 of the charging apparatus 1.

In step S202, information of the portable telephone set 9, e.g., its telephone number is inputted via the private information input unit 11 of the target charging apparatus 1, and sent to the information processor 4.

In step S203, the information processor 4 of the target charging apparatus 1 sends a charging start request of starting charging to the charging controller 5 in order to notify the latter of the completion of charging preparations.

In step S204, the charging start request information received by the information processor 6 of the charging controller 5 is transmitted to the message transmission/reception unit 8.

In step S205, the message transmission/reception unit 8 sends a message to the portable telephone set 9 on the basis of the information of the portable telephone set 9.

If the start of charging is permitted in step S206, a corresponding operation is performed to send transmission start OK information from the portable telephone set 9 to the message transmission/reception unit 8 of the charging controller 5.

In step S207, the message transmission/reception unit 8 analyzes the information sent from the portable telephone set 9. By this analysis, the portable telephone set 9 is identified.

In step S208, the message transmission/reception unit 8 sends energization start request information to the information processor 6.

In step S209, the information processor 6 transmits the energization start request information to the information processor 4 of the target charging apparatus 1.

In step S210, the information processor 4 of the target charging apparatus 1 receives the energization start request information.

In step S211, the target charging apparatus 1 notifies the power controller 2 of the energization start request.

In step S212, the target charging apparatus 1 sends energization start information to the charging controller 5.

In step S213, the information processor 6 receives the energization start information.

In step S214, the charging controller 5 transmits use start information to the used amount management unit 7.

As shown in FIG. 4B, in step S215, the used amount management unit 7 starts measuring the use time.

In step S216, the mounting/dismounting unit 3 of the target charging apparatus 1 monitors whether the portable telephone set 9 is fully charged or is mounted.

If any event occurs in step S217, e.g., the portable telephone set 9 is dismounted, energization stops in the target charging apparatus 1.

In step S218, the target charging apparatus 1 transmits energization stop information to the information processor 4.

In step S219, the information processor 4 of the target charging apparatus 1 transmits the received energization stop information to the charging controller 5.

In step S220, the information processor 6 receives information representing the end of charging.

In step S221, the charging controller 5 notifies the used amount management unit 7 of the charging end information.

In step S222, the used amount management unit 7 ends the measurement of the use time of the charging apparatus, and transmits information such as a used fee thereof and a charged time thereof to the message transmission/reception unit 8.

In step S223, the message transmission/reception unit 8 transmits the information sent from the used amount management unit 7 to the portable telephone set 9.

In step S224, the portable telephone set 9 confirms the use fee or the like contained in the information transmitted from the charging controller 5.

In step S225, as for billing, a dealer who possesses the portable telephone set charging system bills the user the used fee of the charging apparatus on the basis of the telephone number and the used time of the charging apparatus.

According to the present invention, a telephone number is inputted as private information from the portable telephone set 9 to the charging apparatus 1. The inputted information is exchanged between the portable telephone set 9 and the portable telephone set charging system. The portable telephone set charging system can authenticate the user, and can bill the user the used fee of the portable telephone set charging system. Even if the user does not have any cash on him or her, he/she can charge the portable telephone set 9. The user can easily charge the portable telephone set 9 outside his or her home without adding any new function to the portable telephone set 9.

What is claimed is:

1. A charging system for charging a portable telephone set, comprising:
a plurality of charging apparatuses which can simultaneously charge a plurality of portable telephone sets; and
a charging controller which causes said charging apparatuses to start charging on the basis of exchange of information with said portable telephone sets via a base station, identifies said portable telephone sets, and bills the user for use of said charging apparatuses.

2. A system according to claim 1, wherein
said charging controller comprises a message transmission/reception unit which exchanges information with said portable telephone sets via said base station, and
said message transmission/reception unit receives charging start request information from each of said portable telephone sets, transmits charging start confirmation information as a response to the charging start request information to said portable telephone set, and receives transmission start OK information as a response to the charging start confirmation information from said portable telephone set.

3. A system according to claim 1, wherein when each of said portable telephone sets is mounted on each of said charging apparatuses and said charging apparatus receives charging start request information from said portable telephone set via said charging controller, said charging controller transmits charging start confirmation information to said portable telephone set.

4. A system according to claim 1, wherein
each of said charging apparatuses comprises a private information input unit, and
when private information is received by said private information input unit of each of said portable telephone sets, said message transmission/reception unit transmits charging start request information to said portable telephone set on the basis of the private information, and receives charging start information as a response to the charging start request information from said portable telephone set.

5. A system according to claim 1, wherein said charging controller provides used fee information to each of said portable telephone sets.

6. A system according to claim 1, wherein said plurality of charging apparatuses and said charging controller are connected by wire or wirelessly.

7. A system according to claim 1, wherein said plurality of charging apparatuses and said charging controller are integrated.

8. A system according to claim 1, wherein when each of said portable telephone sets is empty of battery capacity, said portable telephone set is charged for a predetermined time until start of actual charging without exchanging information between said portable telephone set and said charging controller.

9. A system according to claim 1, wherein a dealer different from a dealer for said portable telephone set charging system provides charging of said charging apparatuses.

10. A system according to claim 1, wherein the user is billed a used fee for use of said charging apparatuses together with a telephone rate.

11. A portable telephone set charging method, comprising the steps of:
simultaneously charging a plurality of portable telephone sets;
starting charging on the basis of exchange of information with the portable telephone sets;
identifying the portable telephone sets; and
billing the user for charging of the portable telephone sets.

12. A portable telephone set charging method, comprising the steps of:
simultaneously charging a plurality of portable telephone sets;
starting charging on the basis of exchange of information with the portable telephone sets via a base station;
identifying the portable telephone sets; and
billing the user for charging of the portable telephone sets.
